(19) United States
(12) Patent Application Publication
(10) Pub. No.: US 2024/0280536 A1
(43) Pub. Date: Aug. 22, 2024

(54) PERMANENT ELECTROMAGNET SENSOR TO DETECT THE END OF REVERSE CEMENTING

(71) Applicant: Halliburton Energy Services, Inc., Houston, TX (US)

(72) Inventors: Hector Jesus Elizondo, Houston, TX (US); Jinhua Cao, Houston, TX (US); Ritesh Dharmendra Panchal, Houston, TX (US)

(21) Appl. No.: 18/170,813

(22) Filed: Feb. 17, 2023

(51) Int. Cl. G01N 27/74; E21B 49/08; G01N 15/08

(52) U.S. Cl. CPC G01N 27/74; E21B 49/08; G01N 15/0806

(57) ABSTRACT

Some implementations may relate to methods and apparatuses configured to remove magnetic particles from a sensor in a wellbore. In some implementations, an apparatus may be configured for placement in a downhole tubular and reduction of magnetic debris accumulation on a downhole sensor. The sensor may include a permanent electromagnet including a permanent magnet configured to emit a first magnetic field, a bobbin coupled with the permanent magnet, a ferrite rod disposed along a longitudinal axis within the bobbin. The sensor also may include a coil wound around the bobbin and configured to receive voltage and emit a second magnetic field to temporarily neutralize the first magnetic field of the permanent magnet.

### TECHNICAL FIELD

The disclosure generally relates to the field of equipment utilized and operations performed in cementing a subterranean well and, more specifically, magnetic sensing downhole tools used during a cementing operation.

### BACKGROUND

Reverse circulation cementing (hereinafter “reverse cementing”) involves displacing fluids between the outside of a casing and a formation wall in a subterranean well operation. A sensor coupled with a permanent electromagnet on the inner or outer diameter of the casing at or near the bottom of the wellbore may detect when the cementing fluids reach the bottom of the wellbore and begin entering the inside of the casing through a flow port. In response, a signal may be sent to close a valve or sleeve to prevent cementing fluids from ascending the inside of the casing. One such cementing fluid, such as a spacer fluid, may be used to clean the wellbore of drilling fluids/mud prior to cementing the well. The cementing fluid may comprise magnetic particles detectable by the sensor. Accumulation of magnetic particles on the sensor may inhibit its function, which could lead to a failure to halt cement intrusion inside the casing. Therefore, dynamic control of the permanent electromagnet's magnetic field may assist in clearing the sensor of magnetic debris.

### BRIEF DESCRIPTION OF THE DRAWINGS

Embodiments of the disclosure may be better understood by referencing the accompanying drawings.

FIG. 1 depicts a cross-section of an exemplary reverse cementing operation with a downhole sensor comprising a permanent electromagnet, according to some embodiments.

FIG. 2 depicts a schematic diagram of a system component arrangement in the borehole, according to some embodiments.

FIG. 3 is a diagram illustrating an example permanent electromagnet.

FIG. 4 is a diagram illustrating the permanent electromagnet 207 coupled with an example printed circuit board.

FIG. 5 depicts a plot of an example sensor response to 1% Magnetite spacer fluid during a reverse cementing process.

FIG. 6 depicts a plot of a sensor response to 2% Magnetite spacer fluid, according to some embodiments.

FIG. 7 is a flowchart of example operation for monitoring magnetic debris buildup on a sensor, according to some embodiments.

FIG. 8 depicts an example acquisition and measurement system.

### DESCRIPTION OF EMBODIMENTS

The description that follows includes example systems, methods, techniques, and program flows that embody embodiments of the disclosure. However, this disclosure may be practiced without these specific details. For instance, this disclosure refers to reducing magnetic particle accumulation on a permanent electromagnet sensor plug assembly during a reverse cementing operation in illustrative examples. Embodiments of this disclosure may be instead applied to magnetic sensor cleaning during other subterranean wellbore operations including traditional cementing operations. In other instances, well-known instruction instances, protocols, structures, and techniques have not been omitted for clarity.

### Overview

Well operators may perform a reverse cementing process during which a slurry is pumped into the annular space between a formation wall and tubing in the wellbore. Downhole sensors may provide information about the slurry and other aspects of the reverse cementing process. Some of the sensors may cooperate with permanent electromagnets. However, off-the-shelf permanent electromagnets may not be able to maintain their magnetic field in high downhole temperatures and various downhole conditions. Some implementations include a temperature-resistant permanent electromagnet configured for use in reverse cementing processes. The permanent electromagnet may include a Samarium Cobalt magnet that enables the permanent electromagnet to reliably operate in high downhole temperatures and other extreme conditions in the downhole environment. The permanent electromagnet also may include other components (such as such as a coil, bobbin, and rod) hardened for downhole use. The temperature-resistant permanent electromagnet may be coupled with a sensor (such as a Hall effect sensor) and included in a sensor plug assembly deployed in the wellbore (such as embedded in a tubular) during the reverse cementing process.

At designated stages of the reverse cementing process, a material with high magnetic permeability may be added to a slurry to enable the downhole sensor to detect a change to the magnetic permeability (also referred to as the Hall effect) of the slurry. The sensor plug assembly may be situated downhole near a flow port to detect the presence of known magnetic permeability corresponding to the slurry sent downhole. Magnetic particles within the slurry may accumulate over time on the sensor plug assembly as the magnetic particles are attracted to the magnet source. Over time, magnetic particle buildup may inhibit the ability of a sensor in the sensor plug assembly to make accurate readings. Thus, a computing device may be configured to apply a voltage from a power source at certain time intervals to the electromagnet in the sensor plug assembly. The voltage may temporarily neutralize a magnetic field emitted by the permanent magnet. When the magnetic field is neutralized, the slurry may wash away accumulated particulates, and the sensor in the sensor plug assembly may return to normal function until the process is repeated.

### Example Illustrations

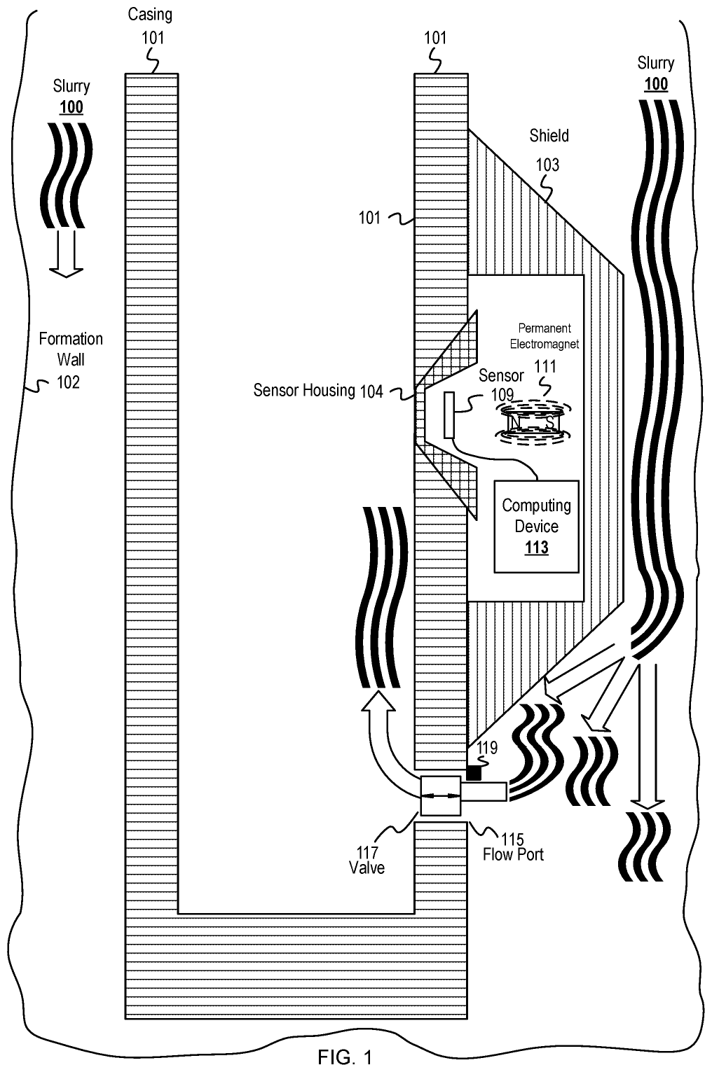

FIG. 1 is a cross-section of an exemplary reverse cementing operation with a downhole sensor and a permanent electromagnet, according to some embodiments. During reverse cementing operations, a slurry 100 of cementing fluids may flow outside an oilfield tubular 101, adjacent to a formation wall 102, and into a flow port 115 after which it is detected by a downhole sensor 109. The downhole sensor 109 may include a magnetic sensor. The downhole sensor 109 may be coupled with a permanent electromagnet 111 and a computing device 113. The downhole sensor 109 also may be coupled with a sensor housing 104. The downhole sensor 109 also may be coupled with a shield 103 that protects the downhole sensor 109 from the slurry 100 on the outside of the oilfield tubular 101. In some embodiments, the downhole sensor 109 may be situated between the permanent electromagnet 111 and the sensor housing 104. In alternate embodiments, the downhole sensor 109 and permanent electromagnet 111 may be placed anywhere along a flow path of the slurry 100.

The permanent electromagnet 111 may be positioned within the sensor housing 104 to induce a magnetic field outside of the sensor housing 104 into the interior of the oilfield tubular 101. The sensor housing 104 may be positioned near the flow port 115 so that the presence of the slurry 100 may be detected as the slurry 100 enters the interior of the oilfield tubular 101. In some embodiments, the sensor housing 104 may comprise non-ferromagnetic material. The downhole sensor 109 may be integrated into the oilfield tubular 101 prior to deployment downhole. In some implementations, the permanent electromagnet 111 may be powered by a battery (not show in FIG. 1) upon deployment of the oilfield tubular 101 to preserve battery power.

The sensor housing 104 may comprise any suitable non-ferromagnetic material (i.e., material having low magnetic permeability) that may allow the passage of the magnetic field of the permanent electromagnet 111 into the slurry 100. For instance, the non-ferromagnetic material may comprise steel, titanium, aluminum, any alloys thereof such as INCONELR alloy, MONELR, MP35N, plastics, composites, ceramics, glass, etc. The sensor housing 104 and shield 103 may comprise any low-cost material that may protect the downhole sensor 109 under operational conditions (e.g., carbon steel, steel alloys, etc.). The downhole sensor 109 may comprise a Hall effect sensor and any other suitable components. In some embodiments, the downhole sensor 109 may include any sensor that detects the strength of a magnetic field or magnetic flux such as a giant magnetoresistance (GMR) sensor, a microelectromechanical magnetic field sensor, magnetic force sensor, etc.

The measurements taken by the downhole sensor 109 may increase in strength as the magnetic permeability of the slurry 100 increases due to increased concentrations of a high magnetic permeability material in the slurry 100. The slurry 100 may comprise a spacer fluid or similar detection slurry having a plurality of particles with a high magnetic permeability such as suspended iron particles, martensitic stainless-steel particles, ferritic particles, iron oxide particles, ferrofluid particles, or other particles with a high magnetic permeability in a fluid. As the magnetic permeability of the slurry 100 increases, the magnetic flux detected by the downhole sensor 109 may also increase.

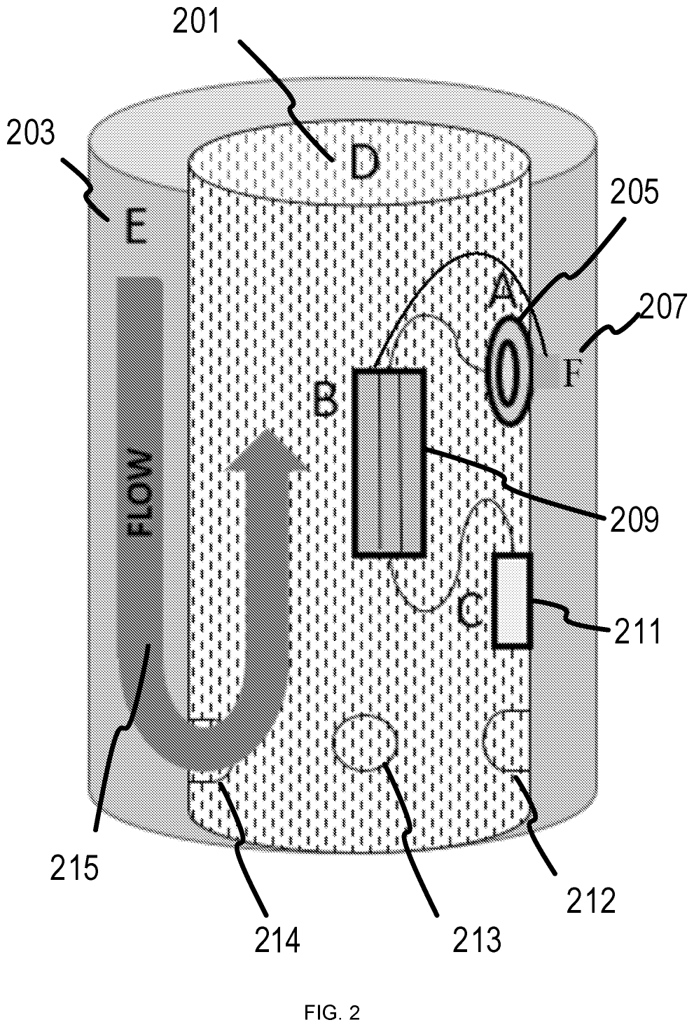

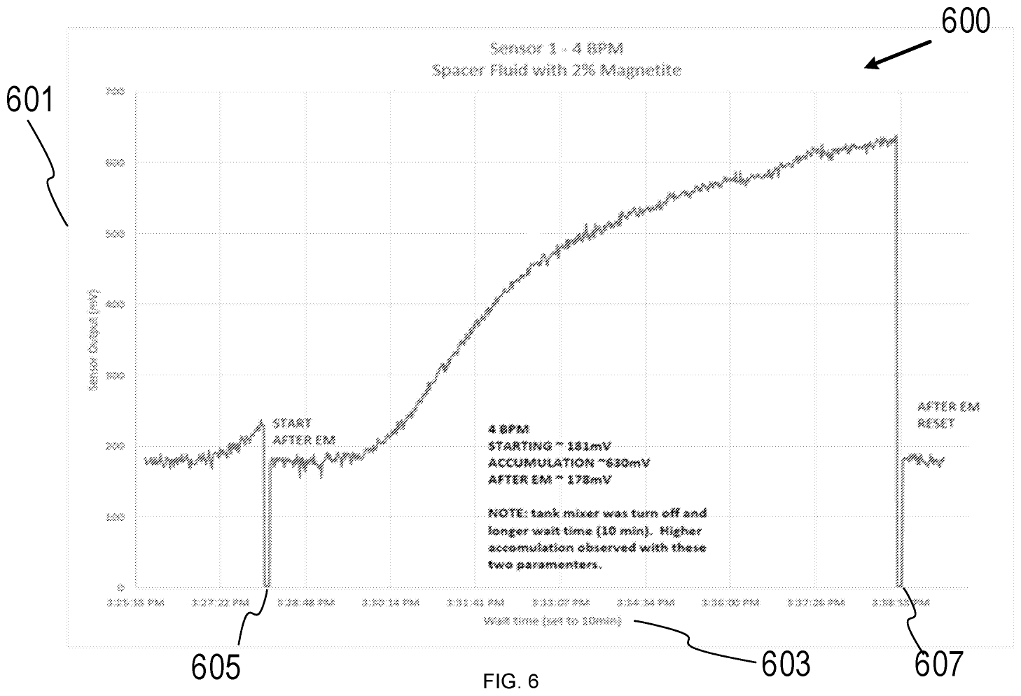

FIG. 2 is a schematic diagram of an example component arrangement in the borehole. FIG. 2 depicts a work string 201 during a reverse cementing operation, where a slurry 215 may travel down an annulus 203 and enter the work string 201 through flow ports 212-214 (similar to those in FIG. 1). A sensor assembly 205 may be situated proximate to a permanent electromagnet 207. The sensor assembly 205 may comprise a Hall effect sensor, a plug to contact the slurry 215, and a printed circuit board (PCB) which may be coupled with various components. The permanent electromagnet 207 and sensor assembly 205 may be further coupled with an acquisition and measurement system 209. The acquisition and measurement system 209 may function similarly to the computing device 113 of FIG. 1. In some embodiments, the acquisition and measurement system 209 may be configured to receive measurements from the sensor assembly 205 and, based on the measurements, actuate an actuator 211. The acquisition and measurement system 209 may comprise a controller board including a controller or processor that, in some embodiments, may control various timing sequences (explained with further detail in the description of FIG. 6) and, in some embodiments, a timing of measurements taken by the Hall effect sensor within the sensor assembly 205. The actuator 211 may be coupled with a flow sleeve (not shown) that may be actuated to close the flow ports 212-214 at an end of the reverse cementing operation. Timing this closure correctly may depend upon accurate readings from the sensor assembly 205—closing the sleeve too early or too late may negatively impact the reverse cementing operation. Thus, ensuring the sensor remains accurate and free of magnetic debris throughout the operation may be advantageous.

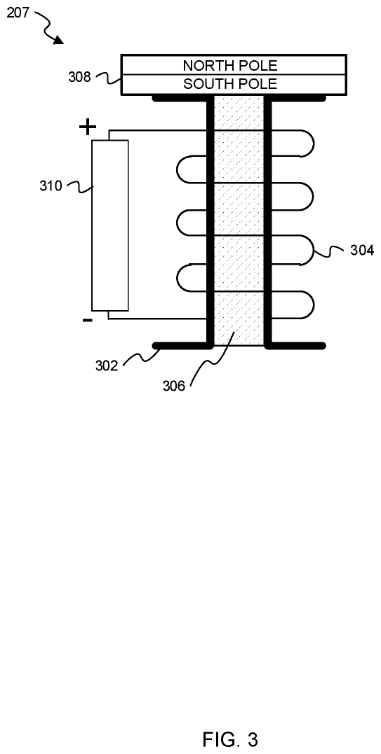

In some embodiments, the sensor assembly 205 may accumulate magnetic debris as magnetic particles are attracted to and deposit on or proximate to the permanent electromagnet 207. The permanent electromagnet 207 may include a permanent magnet that may generate a permanent magnetic field around the permanent electromagnet 207 and the sensor assembly 205. Over time, the accumulation of magnetic particles may inhibit the sensor assembly's ability to accurately measure the Hall effect within the slurry 215. Therefore, the acquisition and measurement system 209 may include a timing sequence where, at certain time intervals, the permanent electromagnet may be supplied power to dynamically control the magnetic field around the sensor assembly 205. When a voltage is applied to a coil surrounding the permanent magnet (described further in FIG. 3), the magnetic field generated by the permanent magnet may be neutralized. At each time interval when the magnetic field is neutralized, the slurry 215 may remove and wash away debris from the sensor assembly 205. In some embodiments, the sensor assembly 205 may be depicted as facing towards the inside of the work string 201. However, the sensor assembly 205 may alternatively face the outside of the work string 201 to detect the slurry. 5 before it enters the interior of the work string 201.

In some embodiments, the slurry 215 may comprise a cementing fluid such as a cement slurry, a spacer, a brine, a mud, or any fluid used during the cementing process (e.g., to cement the outside of the work string 201 or to clean cuttings out of the borehole due to drilling). Each cementing fluid in the slurry 215 may have a magnetic permeability, and the magnetic permeability of each fluid may be modified by adding ferromagnetic material of a prespecified concentration.

FIG. 3 is a diagram illustrating an example permanent electromagnet. The permanent electromagnet 207 may comprise a permanent magnet 308, bobbin 302, rod 306, and coil 304. The coil 304 may be connected to a power supply 310. In some implementations, the permanent electromagnet 207 may be used in conjunction with the sensor assembly 205 or other components described herein.

In some implementations, the permanent magnet 308 may create a persistent magnetic field. The persistent magnetic field may change as high magnetic permeability fluid passes the permanent magnet 308. The sensor assembly 205 may detect the changes in the persistent magnetic field. The permanent magnet 308 may be a samarium-cobalt magnet made primarily from samarium and cobalt. However, the permanent magnet 308 may be made of any other material(s) suited for the purposes described herein, such as for the purpose of producing a particular persistent magnetic field in a specified temperature range and specified downhole conditions. In some implementations, the permanent magnet 308 will maintain a magnetic field of specified strength in a temperature range up to and beyond 120 degrees Celsius. The permanent magnet may be oriented with its south pole closest to the bobbin 302 and its north pole opposite the south pole (see FIG. 3). However, the permanent magnet 308 may be coupled with the bobbin (or any other component(s) of the permanent electromagnet 207) at any suitable orientation. The permanent magnet 308 may have any suitable polarity, such as where the north pole is on a right side of the permanent magnet 308 and the south pole is on the left side, or vice versa. The permanent magnet 308 may be configured to exhibit specific properties such as size, magnetic field strength, polarity, etc. to enable detection and removal of specific magnetic particles in a specific reverse cementing process. For example, the permanent magnet 308 may be configured to emit a magnetic field suitable for detecting magnetic particles in 1% magnetite spacer fluid in a reverse cementing process.

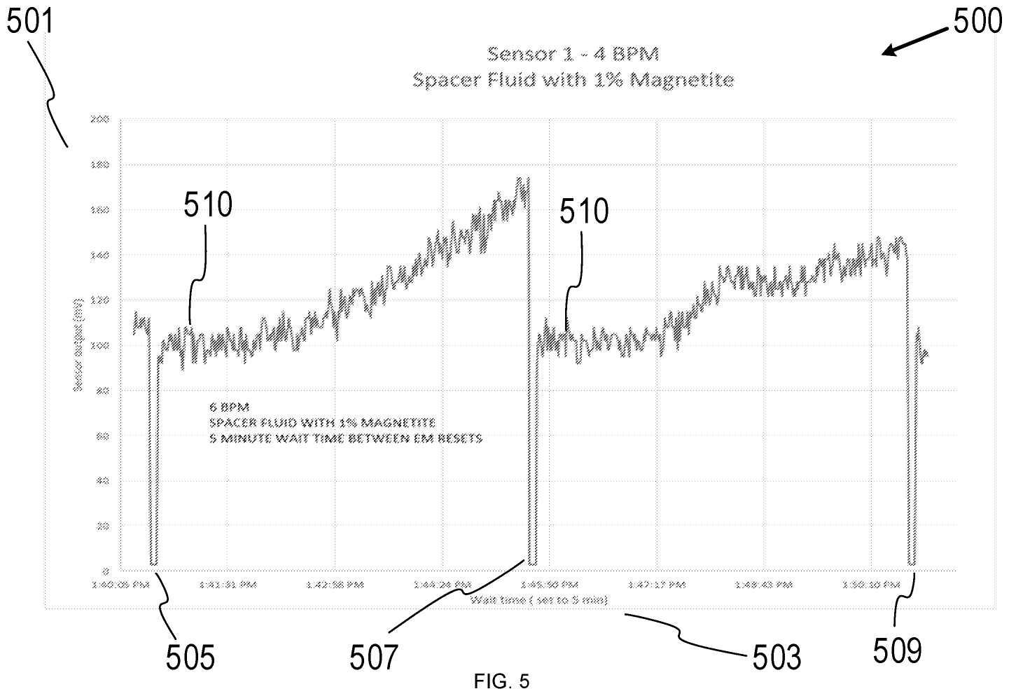

The power supply 310 may provide power to the coil 304. The power supply 310 may include a battery of any suitable type such as a lithium-ion battery. The power supply 310 may be suitable for providing power to the electromagnet over time intervals suited for removing magnetic particles from the sensor assembly 205. The acquisition and measurement system 209 may select time intervals based on battery life of the power supply 310 or well conditions (such as flow rate, volume of spacer fluid, and/or other conditions) (e.g., see discussion of FIG. 5).

When the coil 304 is supplied with power from a power supply 305 (such as a downhole battery, surface power connection, or similar equipment), the coil 303 may generate a magnetetic field. The coil's magnetic field may neutralize the magnetic field generated by the permanent magnet 308. The coil 304 may include any suitable number of turns to produce a magnetic field suitable for the operations described herein. For example, the coil 304 may include 1100 turns of a conductor (such as copper) wound around the bobbin 302.

The bobbin 302 may include a rod 306 to increase the magnetic field generated by the coil 304. The shape and size of the bobbin 302 and rod 306 may depend on various factors, such as the number of coil turns needed to create a specified magnetic field (such as a magnetic field necessary to neutralize the permanent magnet's magnetic field). For example, if 500 coil turns are needed to create a specified magnetic field, the bobbin 302 may be smaller than implementations that have more coil turns. For one example configuration, the rod 306 may be of cylindrical shape having an 18 mm diameter and 10 mm height. The rod 306 may be made of ferrite material that magnifies the magnetic field created by the coil 303. In some implementations, the ferrite material is lighter than steel and can magnify the magnetic field better than steel.

The specific size, shape, material composition, or any other relevant property of each component of the permanent electromagnet 207 may be adjusted based on the desired magnetic performance of that component. For example, a given magnetic flux strength and magnetic field strength may be needed for the permanent magnet 308. Additionally, there may be a desired amount of neutralization for the magnetic field of the permanent magnet 308. For example, to remove magnetic particles from the sensor assembly 205, the electromagnet (coil 304, bobbin 302, rod 306, and power supply 310) may need to neutralize 85% of the magnetic field of the permanent magnet 308. Many different implementations may achieve the desired neutralization amount by adjusting different parameters, such as size, shape, and material composition of the coil 304, bobbin 302, and rod 306. For example, a first implementation of the permanent electromagnet 207 may have a particular bobbin 302 and rod 306 with a number of coil turns. A second implementation may achieve identical performance with fewer coil turns, a smaller bobbin 302 and a larger rod 306.

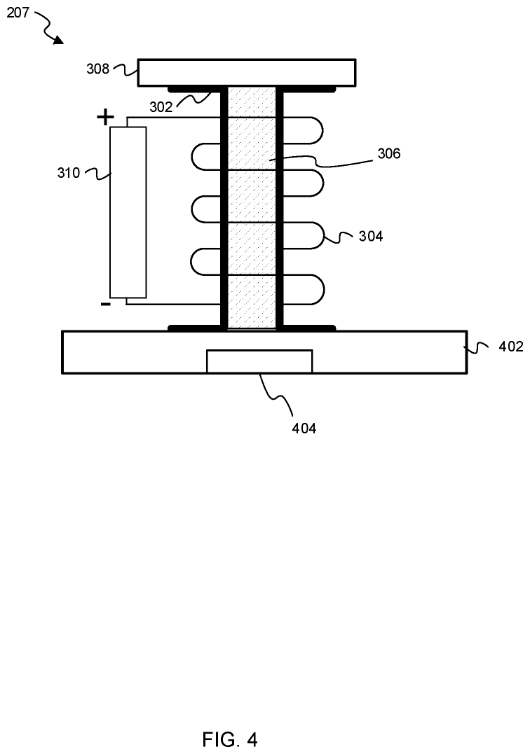

FIG. 4 is a diagram illustrating the permanent electromagnet 207 coupled with an example printed circuit board. The permanent electromagnet 207 may be coupled with an example printed circuit board (PCB) 402. The PCB 402 may include a sensor 404, such as a Hall effect sensor configured to detect presence and magnitude of a magnetic field. The PCB 402 and permanent electromagnet 207 may cooperate as described in FIG. 2. For example, the PCB 402 and sensor 404 may be included in the sensor assembly 205.

In some implementations, the sensor 404 may be placed on the bottom-side of the PCB 402, as shown in FIG. 4. However, the sensor 404 may be placed at any location on the PCB 402 that is suitable for performing the operations described herein. The PCB 402 also may include one or more components configured to transmit data from the sensor 404 (referred to as sensor data) to one or more remote computing devices (such as the remote computing device 113 shown in FIG. 1). For example, the PCB 402 may include a modem, radio, or other suitable transmission device capable of transmitting sensor data indicating information about magnetic fields detected by the sensor 404. The sensor data may indicate sensor readings by the sensor 404. The sensor data may indicate a magnitude of a magnetic field detected by the sensor 404, a time period during which the magnetic field was detected, a time period during which no magnetic field was detected, time stamps associated with sensor readings, and/or any other information suitable for use with the operations described herein.

As noted, the permanent electromagnet may be part of a system that facilitates a reverse cementing process. During the reverse cementing process, the system may pulse (i.e., turn on and off) power to the coil 304 of the permanent electromagnet 207 to neutralize a magnetic field near the sensor assembly 205. When the magnetic field is neutralized, fluid may wash magnetized particles away from the sensor assembly 205. The discussion of FIGS. 5 and 6 describes neutralizing a magnetic field during a reverse cementing process.

FIG. 5 depicts a plot of an example sensor response to 1% Magnetite spacer fluid during a reverse cementing process. The plot 500 depicts a relationship between a sensor output 501 (such as sensor data transmitted from the sensor 404) in millivolts (mV) over a wait time 503. The spacer fluid may be one of the cementing fluids previously discussed. The spacer fluid may comprise 1% Magnetite particulates, and the spacer fluid (similar to the slurry 215 of FIG. 2) may flow at a rate of 4 barrels per minute (bpm). Sensor output may increase over time due to magnetic debris accumulating on a sensor (such as sensor 404) in the sensor assembly 205. This upward trend in sensor output may be halted and corrected if the magnetic debris is removed from the sensor. At electromagnet resets (“EM reset”) 505, 507, and 509, sensor output steeply declines and temporarily plateaus upon neutralization of the magnetic field of a permanent magnet (such as permanent magnet 308) in the sensor assembly 205. Each of the EM resets 505-509 may last for a designated time period (e.g., a waiting time of 5 seconds), depicted as a sensor output of <5 mV. During each EM reset, flow of the spacer fluid at 4 bpm may wash away magnetic debris accumulated on a surface of the sensor assembly 205 (or otherwise near the sensor 404) while the magnetic field is neutralized. After each EM reset, the sensor output may return to a baseline measurement 510) (approx. 100 mV), which may be consistent with expected measurements from a clean sensor. The acquisition and measurement system 209 may be configured to implement a buildup cycle of 5-minute intervals between EM resets, where each buildup cycle refers to the time interval where the magnetic field is active and sensor output builds due to magnetic particle accumulation.

As noted, to neutralize the magnetic field during the EM resets 505-509, the power supply 310 may provide power to the coil 304. If the power supply 310 includes a battery, battery life may depend on the number and duration of EM resets. Additionally, battery life may depend on the strength of the permanent magnet 308, amount of desired neutralization, strength of the electromagnet, and other factors. The power supply 310 may increase battery life by having fewer reset periods, lower power needed to neutralize the permanent magnet's magnetic field, etc. Hence, some implementations may design the permanent electromagnet 207 and neutralization process (such as frequency of EM resets) to optimize battery life of the power supply 310. Some implementations may alter the duration of the EM reset based on battery life. For example, as battery life reduces, the acquisition and measurement system 209 may reduce the duration of EM resets, such as from 5 seconds to 4 seconds (or to any suitable duration).

FIG. 6 depicts a plot of a sensor response to 2% Magnetite spacer fluid, according to some embodiments. The plot 600, similar to plot 500 of FIG. 5, depicts a relationship between a sensor output 601 (in mV) and a wait time 603. In some embodiments, the sensor may be the sensor 404 used with the sensor assembly 205 and may detect the Hall effect of magnetic particles within 2% Magnetite spacer fluid. Similar to the plot 500 of FIG. 5, the sensor output 501 may increase over time until the magnetic field of the permanent electromagnet is neutralized at EM resets 605 and 607. In some embodiments, the buildup cycle between the EM resets 605 and 607 may be affected by parameters of the spacer fluid or by the cementing operation itself. For example, the sensor output 601 may climb extensively (compared to the plot 500 of FIG. 5) due to the higher concentration of magnetite in the spacer fluid, a longer buildup cycle between EM resets, and various operational constraints (e.g., an offline tank mixer) which may increase a rate of particle accumulation on the sensor 404 of the sensor assembly 205. Prior to EM reset 607, magnetite accumulation on the sensor nearly triples from a baseline measurement to ˜600 mV. After each EM reset 605 and 607, the sensor may return to the baseline measurement of ˜180 mV. In some embodiments, the acquisition and measurement system 209 may be configured to alter the buildup cycle between EM resets. In some embodiments, the buildup cycle between EM resets 605 and 607 may be configured to last an interval of 10 minutes, although this may be altered to suit various conditions. During each EM reset 605 and 607, the spacer fluid may wash away accumulated magnetic debris on the sensor and return the sensor output to the baseline once voltage to the permanent electromagnet has ceased. Multiple buildup cycles and EM resets may be performed until the reverse cementing operation is complete.

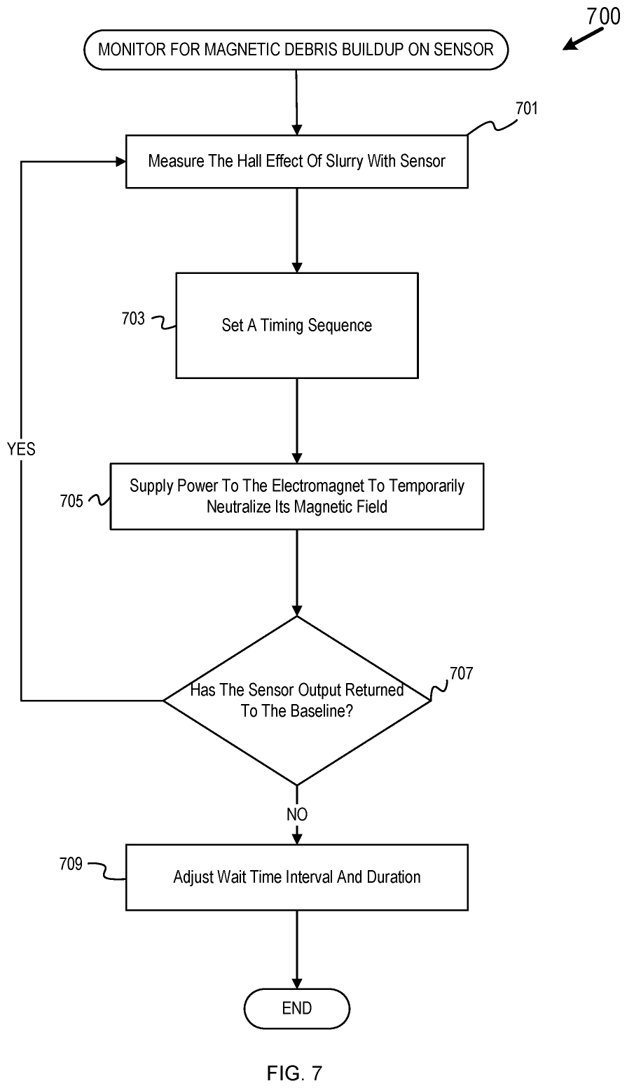

FIG. 7 is a flowchart of example operation for monitoring magnetic debris buildup on a sensor, according to some embodiments. The operations in FIG. 7 are described with reference to a sensor and a processor. These names are for reading convenience and the operations in FIG. 7 may be performed by any component with the functionality described below. Operations of a flowchart 700 begin at block 701.

At block 701, a sensor assembly 205 may measure the Hall effect of magnetic particles within the slurry 215. In some embodiments, the magnetic particles may comprise magnetite or hematite mixed with cementing fluids, such as a spacer fluid, and sent down the annulus 203 as the slurry 215. Flow progresses to block 703.

At block 703, the acquisition and measurement system 209 may set a timing sequence for the permanent electromagnet 207. The timing sequenced may be based on a measured sensor output. For example, in FIG. 5, the sensor output climbs from a baseline measurement 410 to a peak nearing 180 mV. A sensor output far above the baseline may indicate magnetic particle accumulation on the sensor 404. The acquisition and measurement system 209 may activate the permanent electromagnet 207 at set time intervals in the timing sequence. For example, in FIG. 5, EM resets may be configured to occur at 5-minute intervals and may be instructed to last for a waiting time (duration) of 5 seconds each. In FIG. 6, EM resets 605 and 607 occur during a buildup cycle 10 minutes apart and similarly last for 5 seconds each. In some embodiments, both the waiting time of each EM reset and the time between EM resets (buildup cycle) may be configured depending on constraints of the power supply and how often the sensor 404 may require cleaning. Flow progresses to block 705.

At block 705, power may be supplied to the permanent electromagnet to temporarily neutralize its magnetic field. The acquisition and measurement system 209 may instruct the power supply 310 to apply a voltage to the coil 304. The electrified coil may temporarily change polarity of the permanent magnet 308 which may neutralize its magnetic field. With reference to FIG. 2, magnetic debris accumulated on the sensor assembly 205 may be washed away by the slurry 215 while the magnetic field is neutralized. The flow of the slurry 215 alone may not be sufficient to completely clean the Hall effect sensor of debris if the magnetic field is active. Therefore, in some instances, a combination of the discussed electromagnet's magnetic field modulation and fluid flow of the slurry may facilitate sufficient cleaning of the sensor assembly 205. After a waiting time (during which the sensor assembly 205 is cleaned by the slurry 215) has expired, voltage supply to the coil 304 may cease, and the magnetic field of the permanent magnet 308 may return to its prior strength.

In some embodiments, the acquisition and measurement system 209 and power supply 310 may be configured to change the polarity of the permanent magnet core 301 to double its strength. For example, in scenarios where the slurry 215 has a decreased concentration of magnetic material, the permanent electromagnet 207 may be configured to double its magnetic field which may enable more accurate readings by the sensor assembly 205. Flow progresses to block 707.

At block 707, the acquisition and measurement system 209 determines whether the sensor output has returned to its baseline. For example, after each of the EM resets 405-409 and 505-507, the sensor output returns to a baseline measurement of sensor output. In FIG. 4 after EM reset 407, the sensor output may return to the baseline measurement 410 around 100 mV, indicating that sensor cleaning during the EM reset was successful. If the sensor output returns to its baseline, flow returns to block 701, where the sensor assembly 205 may continue measuring the Hall effect of magnetic particles within the slurry 215. This cycle may repeat a plurality of times until the reverse cementing operation has concluded. If the sensor output does not return to its baseline, flow progresses to block 709 where corrective action may be taken.

At block 709, the acquisition and measurement system 209 may adjust a wait time interval and duration. The wait time interval may refer to the buildup cycle described in FIGS. 5 and 6. The wait time duration may describe the duration of each EM reset. For example, if the sensor output of block 707 did not return to its baseline output, the duration of the EM reset may have been insufficient. The slurry 215 may not have cleared all or most of the magnetic debris accumulated on the sensor assembly 205 and may require a longer EM reset duration to do so. In some embodiments, the slurry 215 may comprise increased concentrations of magnetic particles. At increased concentrations, magnetic particles may deposit on the sensor assembly 205 at an increased rate, and the wait time interval (buildup cycle) may be shortened to accommodate. In some implementations, the acquisition and measurement system 209 may adjust the wait time and/or the EM reset time based, at least in part, on battery life of the power supply 310. For example, as the battery life drains to a threshold, the acquisition and measurement system 209 may shorten the EM reset duration and/or lengthen the wait time interval. Both the wait time interval and wait time duration, collectively referred to as time parameters, may be adjusted through the acquisition and measurement system 209 between cementing operations.

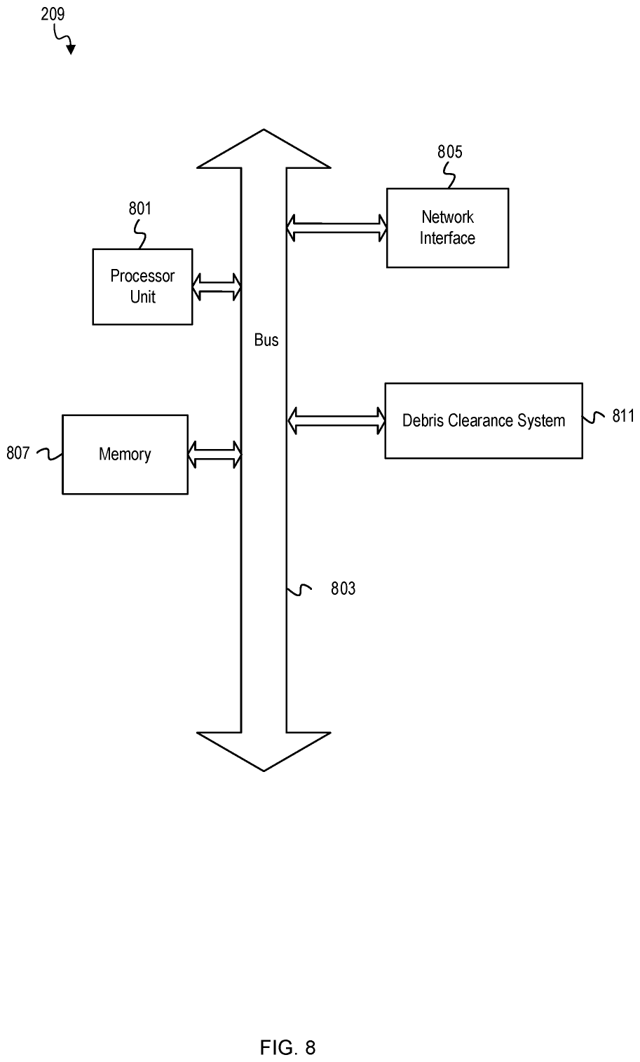

FIG. 8 depicts an example acquisition and measurement system 209. The acquisition and measurement system 209 may include a processor 801 (possibly including multiple processors, multiple cores, multiple nodes, and/or implementing multi-threading, etc.). The acquisition and measurement system 209 may include memory 807. The memory 807 may be system memory or any one or more of the above already described possible realizations of machine-readable media. The acquisition and measurement system 209 may also include a bus 803 and a network interface 805. The acquisition and measurement system 209 may communicate via transmissions to and/or from remote devices via the network interface 805 in accordance with a network protocol corresponding to the type of network interface, whether wired or wireless and depending upon the carrying medium. In addition, a communication or transmission may involve other layers of a communication protocol and or communication protocol suites (e.g., transmission control protocol, Internet Protocol, user datagram protocol, virtual private network protocols, etc.). The acquisition and measurement system 209 also includes a debris clearance system 811. The debris clearance system 811 may adjust timing parameters such as the timing sequence between EM resets of the downhole sensor (i.e., when the permanent electromagnet is neutralized and fluid flow washes away accumulated debris) or the duration of each EM reset (as described herein). The debris clearance system 811 may additionally be configured to apply voltage from a power source to the permanent electromagnet (as described herein). Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

While the aspects of the disclosure are described with reference to various implementations and exploitations, it will be understood that these aspects are illustrative and that the scope of the claims is not limited to them. In general, techniques for measuring the Hall effect of a slurry via a sensor and techniques for cleaning the sensor of accumulated magnetic debris as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” may be infringed with only one of the listed items, multiple of the listed items, and one or more of the items in the list and another item not listed.

### EXAMPLE IMPLEMENTATIONS

Clause 1: An apparatus configured for placement in a downhole tubular and reduction of magnetic debris accumulation on a downhole sensor, the apparatus comprising: a permanent electromagnet including a permanent magnet configured to emit a first magnetic field, a bobbin coupled with the permanent magnet, a ferrite rod disposed along a longitudinal axis within the bobbin, and a coil wound around the bobbin and configured to receive voltage and emit a second magnetic field to temporarily neutralize the first magnetic field of the of the permanent magnet.

Clause 2: The apparatus of clause 1 further comprising: a printed circuit board (PCB) coupled with the coil, the PCB including the downhole sensor, the downhole sensor configured to detect magnetized particles suspended in fluids of a reverse cementing process.

Clause 3: The apparatus of any one or more of clauses 1-3, wherein the PCB is in electronic communication with a computing device including a computer-readable medium including computer-executable instructions comprising: instructions to control supply of the voltage from a power supply to periodically neutralize the first magnetic field for a time period in which a first fluid can remove at least some of the magnetic debris from the downhole sensor.

Clause 4: The apparatus of any one or more of clauses 1-3, wherein the power supply includes a battery, wherein the time period is selected based on one or more conditions in a well in which the apparatus is to be placed.

Clause 5: The apparatus of any one or more of clauses 1-4, further comprising: a battery in electronic communication with the coil to provide the voltage to temporarily neutralize the first magnetic field of the permanent magnet.

Clause 6: The apparatus of any one or more of clauses 1-5, wherein the bobbin is made of high-temperature plastic.

Clause 7: The apparatus of any one or more of clauses 1-6, wherein the permanent magnet is a Samarian cobalt magnet.

Clause 8: The apparatus of any one or more of clauses 1-7, wherein a south pole of the Samarian cobalt magnet is adjacent to the bobbin, and wherein a north pole of the Samarian cobalt magnet is opposite the bobbin.

Clause 9: A system configured for placement in a downhole tubular and reduction of magnetic debris accumulation on a downhole sensor, the system comprising: a permanent electromagnet including a permanent magnet configured to emit a first magnetic field, a bobbin coupled with the permanent magnet, a ferrite rod disposed along a longitudinal axis within the bobbin, and a coil wound around the bobbin and configured to receive voltage and emit a second magnetic field to temporarily neutralize the first magnetic field of the of the permanent magnet: a printed circuit board (PCB) coupled with the permanent electromagnet, the PCB including the downhole sensor, the downhole sensor configured to detect magnetized particles suspended in fluids of a reverse cementing process; and a computing device including a machine-readable medium including instructions executable by the computing device, the instructions including instructions to control supply of the voltage from a power supply to periodically neutralize the first magnetic field for a time period in which a first fluid can move at least some of the magnetic debris away from the downhole sensor.

Clause 10: The system of clause 9, wherein the power supply includes a battery, wherein the time period is selected based on remaining life of the battery.

Clause 11: The system of any one or more of clauses 9-10, further comprising: a battery in electronic communication with the coil to provide the voltage to temporarily neutralize the magnetic field of the permanent magnet.

Clause 12: The system of any one or more of clauses 9-11, wherein the permanent magnet is a Samarian cobalt magnet.

Clause 13: The system of any one or more of clauses 9-12, wherein a south pole of the Samarian cobalt magnet is adjacent to the bobbin, and wherein a north pole of the Samarian cobalt magnet is opposite the bobbin.

Clause 14: The system of any one or more of clauses 9-14, wherein the bobbin is made of high-temperature plastic

Clause 15: A method for reducing magnetic debris accumulation on a downhole sensor within a tubular conveyed in a borehole, comprising: supplying a voltage to temporarily neutralize a first magnetic field of a permanent electromagnet proximate to the downhole sensor, the permanent electromagnet including a permanent magnet configured to emit the first magnetic field, a bobbin coupled with the permanent magnet, a ferrite rod disposed along a longitudinal axis within the bobbin, and a coil wound around the bobbin and configured to receive the voltage and emit a second magnetic field to temporarily neutralize the first magnetic field; and removing magnetic debris on the downhole sensor via a flow of a first fluid in the tubular while the first magnetic field is neutralized.

Clause 15: The system of clause 15 further comprising: ceasing the supply of the voltage to the permanent electromagnet after a waiting time has passed; and analyzing a sensor output of the downhole sensor, wherein the sensor output indicates an extent of the magnetic debris accumulation.

Clause 17: The system of any one or more of clauses 15-16, wherein the waiting time indicates a duration of the voltage supply to the permanent electromagnet, and wherein the waiting time is adjusted based, at least in part, on the extent of magnetic debris removal.

Clause 18: The system of any one or more of clauses 15-17, wherein the downhole sensor is a Hall effect sensor configured for use in a reverse cementing operation, and wherein the supplying and ceasing of the voltage to the permanent electromagnet occurs a plurality of times during the operation.

Clause 19: The system of any one or more of clauses 15-18, wherein the first fluid comprises a slurry, and wherein the slurry comprises magnetic particles detectable by the downhole sensor.

Clause 20: The system of any one or more of clauses 15-19, wherein the voltage originates from a battery, and wherein a timing sequence dictating a length of time for supplying the voltage to the permanent electromagnet is adjusted based on one or more conditions in a wellbore.

What is claimed is:

1. An apparatus configured for placement in a downhole tubular and reduction of magnetic debris accumulation on a downhole sensor, the apparatus comprising:
a permanent electromagnet including
a permanent magnet configured to emit a first magnetic field,
a bobbin coupled with the permanent magnet,
a ferrite rod disposed along a longitudinal axis within the bobbin, and
a coil wound around the bobbin and configured to receive voltage and emit a second magnetic field to temporarily neutralize the first magnetic field of the permanent magnet.

2. The apparatus of claim 1 further comprising:
a printed circuit board (PCB) coupled with the coil, the PCB including the downhole sensor, the downhole sensor configured to detect magnetized particles suspended in fluids of a reverse cementing process.

3. The apparatus of claim 2, wherein the PCB is in electronic communication with a computing device including a computer-readable medium including computer-executable instructions comprising:
instructions to control supply of the voltage from a power supply to periodically neutralize the first magnetic field for a time period in which a first fluid can remove at least some of the magnetic debris from the downhole sensor.

4. The apparatus of claim 3, wherein the power supply includes a battery, wherein the time period is selected based on one or more conditions in a well in which the apparatus is to be placed.

5. The apparatus of claim 1 further comprising:
a battery in electronic communication with the coil to provide the voltage to temporarily neutralize the first magnetic field of the of the permanent magnet.

6. The apparatus of claim 1, wherein the bobbin is made of high-temperature plastic.

7. The apparatus of claim 6, wherein the permanent magnet is a Samarian cobalt magnet.

8. The apparatus of claim 7, wherein a south pole of the Samarian cobalt magnet is adjacent to the bobbin, and wherein a north pole of the Samarian cobalt magnet is opposite the bobbin.

9. A system configured for placement in a downhole tubular and reduction of magnetic debris accumulation on a downhole sensor, the system comprising:
a permanent electromagnet including
a permanent magnet configured to emit a first magnetic field,
a bobbin coupled with the permanent magnet,
a ferrite rod disposed along a longitudinal axis within the bobbin, and
a coil wound around the bobbin and configured to receive voltage and emit a second magnetic field to temporarily neutralize the first magnetic field of the permanent magnet:
a printed circuit board (PCB) coupled with the permanent electromagnet, the PCB including the downhole sensor, the downhole sensor configured to detect magnetized particles suspended in fluids of a reverse cementing process; and
a computing device including a machine-readable medium including instructions executable by the computing device, the instructions including
instructions to control supply of the voltage from a power supply to periodically neutralize the first magnetic field for a time period in which a first fluid can move at least some of the magnetic debris away from the downhole sensor.

10. The system of claim 9, wherein the power supply includes a battery, wherein the time period is selected based on remaining life of the battery.

11. The system of claim 9 further comprising:
a battery in electronic communication with the coil to provide the voltage to temporarily neutralize the magnetic field of the of the permanent magnet.

12. The system of claim 9, wherein the bobbin is made of high-temperature plastic.

13. The system of claim 9, wherein the permanent magnet is a Samarian cobalt magnet.

14. The system of claim 13, wherein a south pole of the Samarian cobalt magnet is adjacent to the bobbin, and wherein a north pole of the Samarian cobalt magnet is opposite the bobbin.

15. A method for reducing magnetic debris accumulation on a downhole sensor within a tubular conveyed in a borehole, comprising:
supplying a voltage to temporarily neutralize a first magnetic field of a permanent electromagnet proximate to the downhole sensor, the permanent electromagnet including
a permanent magnet configured to emit the first magnetic field,
a bobbin coupled with the permanent magnet,
a ferrite rod disposed along a longitudinal axis within the bobbin, and
a coil wound around the bobbin and configured to receive the voltage and emit a second magnetic field to temporarily neutralize the first magnetic field; and
removing magnetic debris on the downhole sensor via a flow of a first fluid in the tubular while the first magnetic field is neutralized.

16. The method of claim 15, further comprising:
ceasing the supply of the voltage to the permanent electromagnet after a waiting time has passed; and
analyzing a sensor output of the downhole sensor, wherein the sensor output indicates an extent of the magnetic debris accumulation.

17. The method of claim 16, wherein the waiting time indicates a duration of the voltage supply to the permanent electromagnet, and wherein the waiting time is adjusted based, at least in part, on the extent of magnetic debris removal.

18. The method of claim 16, wherein the downhole sensor is a Hall effect sensor configured for use in a reverse cementing operation, and wherein the supplying and ceasing of the voltage to the permanent electromagnet occurs a plurality of times during the operation.

19. The method of claim 15, wherein the first fluid comprises a slurry, and wherein the slurry comprises magnetic particles detectable by the downhole sensor.

20. The method of claim 19, wherein the voltage originates from a battery, and wherein a timing sequence dictating a length of time for supplying the voltage to the permanent electromagnet is adjusted based on one or more conditions in a wellbore.
